(19) United States
(12) Patent Application Publication
(10) Pub. No.: US 2011/0241416 A1
(43) Pub. Date: Oct. 6, 2011

(54) ROTARY FORMING METHOD FOR PRODUCING A RIVET FLANGE

(75) Inventors: Andreas Kaiser, Werneck (DE); Roland Langer, Schwanfeld (DE); Sebastian Lorenz, Rothenkirchen (DE)

(73) Assignee: SCHAEFFLER TECHNOLOGIES GMBH & CO. KG, (DE)

(21) Appl. No.: 13/132,837

(22) PCT Filed: Nov. 19, 2009
(86) PCT No.: PCT/EP2009/065490

§ 371 Date: Jun. 3, 2011

(30) Foreign Application Priority Data
Dec. 19, 2008 (DE) 10 2008 064 155.3

(51) Int. Cl. B60B 27/00; F16C 19/22; B21D 53/26

(52) U.S. Cl. 301/109; 384/548; 29/894.362

(57) ABSTRACT

A rotary forming method for producing a rivet flange of a wheel hub on which a wheel bearing is mounted. A rivet flange is formed from a cylindrical part of a wheel huh by a hobbing tool oriented along a direction of the axis of rotation of the wheel hub. The method keeps material stresses low and accurately adjusts the preload of the bearing. For this purpose, first rotating rolling elements of at least one first row of rolling elements of the tool form the rivet flange. Axes of rotation of the first rolling elements form a first angle with the axis of rotation of the rolling bearing during the riveting operation, ensuring uniformity on the entire circumference of the cylindrical part of the wheel hub using a smaller deformation force while allowing the rolling bearing to be temporarily preloaded by a holding element even before the cold forming process.

### FIELD OF THE INVENTION

The invention relates to a rotary forming method for producing a rivet flange of an antifriction bearing, in particular a wheel bearing, a rivet flange being formed from a cylindrical part of a wheel hub of the antifriction bearing by means of a rolling tool which is oriented along a direction of a rotational axis of the wheel hub.

A method of this type is used if a prestress has to be maintained permanently within an antifriction bearing. A prestress of this type runs as a rule through the inner and outer rings, the rolling bodies and the wheel hub; the rivet flange is intended to keep the action chain closed permanently between said components.

For riveting, in antifriction bearings, in particular in wheel bearings, at least the essential components are assembled and subsequently the rivet flange from a cylindrical part of the wheel hub is brought out of its cylindrical shape into a mainly radial shape. Components such as the inner rings, the outer ring or rings, rolling bodies and sealing arrangements including lubrication are typically preassembled.

The riveting according to the prior art takes place by rolling riveting or header riveting. To this end, the rolling riveting tool (also riveting header) is placed on that cylindrical part of the wheel huh which is to be deformed and is set into a tumbling movement, the rivet flange being formed and moved into the correct position by the underside configuration of the riveting header.

It has proven problematical that undesired widening of the inner ring has often been caused during the header riveting method. In addition, great material stresses are produced on the rivet flange in the case of pronounced deformations. Both can lead to the failure or a considerable shortening of the service life of the antifriction bearing. This can occur, in particular, when the rivet flange springs back after the header riveting operation.

Furthermore, the complicated movement sequence of the riveting header implies an apparatus which is complicated to operate and, in conjunction with the limited service life of the riveting header, leads to high costs.

DE 10 2006 019023 A1 has disclosed a method for mounting a wheel bearing unit, which method is based on a riveting header. To this end, the wheel bearing unit is pushed onto the hub shaft and a flange is formed on the hub shaft for axially fixing the inner ring.

### SUMMARY OF THE INVENTION

The invention is based on the object of specifying a rotary forming method which eliminates the abovementioned disadvantages at least to a large extent.

This object is achieved by a rotary forming method of the type mentioned in the introduction, by virtue of the fact that the first rotating rolling bodies of at least one first rolling body row of the rolling tool form the rivet flange, and the rotational axes of the first rolling bodies of the rolling tool form a first angle with the rotational axis of the antifriction bearing during the riveting operation.

Furthermore, the object is achieved by an antifriction bearing, in particular a wheel bearing, of the type mentioned in the introduction, which antifriction bearing has been produced by means of the rotary forming method.

The rotary forming method according to the invention for producing a rivet flange, the rivet flange is formed from a cylindrical part of a wheel hub of an antifriction bearing by means of a rolling tool. To this end, the rolling tool is guided along a direction of a rotational axis of the wheel hub on the cylindrical part of the wheel hub and is set in a rotational movement in relation to said cylindrical part. That is to say, both the wheel hub and the rolling tool can be rotated about the rotational axis of the anti friction bearing for this operation. During the rotation, the wheel hub and the rolling tool are in contact via rolling bodies of the rolling tool for the purpose of force transmission. For this purpose, the rolling bodies can be of cylindrical, conical configuration or of concave or convex configuration in longitudinal section and, during the rotation, roll on the part to be formed of the wheel hub in the circumferential direction. As a result of the force which is transmitted by the rolling bodies, cold forming is achieved which widens the cylindrical part of the wheel hub and presses it radially to the outside. Here, the rivet flange extends beyond the inner radius of the inner ring, whereby the inner ring is axially fixed permanently or the wheel bearing is prestressed via the rolling bodies and the outer ring.

Riveting of the antifriction bearing is therefore brought about by the rolling action of the rolling bodies. This type of cold forming is also called roll forming, and the rolling tool is also called a roll forming tool.

The outer face of the rolling bodies of the rolling tool forms the rivet flange of the antifriction bearing. The rolling bodies can be arranged in one or more rolling body rows. In this way, radially different regions of the rivet flange are machined at the same time. It is a homogeneous operation which makes a defined force transmission to the entire circumference of the wheel hub possible. More than one force direction for forming the rivet flange can be generated at the same time by a plurality of rolling body rows.

A first rolling body row forms, with a rotational axis of its rolling bodies, a first angle with the rotational axis of the antifriction bearing. This can apply correspondingly to a second rolling body row or more rolling body rows.

The rolling tool can advantageously have a defined number of rolling body rows or different rolling tools with only one or two rolling body rows can be applied one after another, with the result that the rivet flange is brought into the desired shape.

The rolling tool advantageously permits more space in the forming region, in particular the access to an inner ring during the riveting operation. As a result, a prestress can already be maintained by a holding element, for example a hold-down, before the completed riveting, by the holding element being placed onto the gear-side inner ring and being prestressed before the riveting. This option is not afforded in the known header riveting method because the riveting header itself takes up a large amount of space and additionally also has to perform a tumbling movement which does not permit preceding prestressing. Moreover, by the disadvantageous gap formation between the rivet flange and the inner ring, as is known from header riveting, is eliminated effectively.

The use of this method leads to antifriction bearings, or wheel bearings, which have a rivet flange which has one or more roll formed faces on the gear side which is/are centered with the rotational axis of the antifriction bearing and encloses/enclose an angle with the latter.

A roll formed face can optionally form one or two annular edges with the adjacent faces which optionally have a roll formed shape which is concave or convex in longitudinal section. The number and the position of the roll formed faces can be selected in such a way that the prestress is maintained in an optimum manner. As an alternative, the roll formed faces can be adapted to the shape of a drive part, such as an articulation bell, with the result that a stable screw connection to the drive part of the drive train is possible.

Further advantageous embodiments and preferred developments of the invention can be gathered from the description of the figures and/or the subclaims.

In the following text, the invention will be described in greater detail and explained using the exemplary embodiments which are shown in the figures, in which:

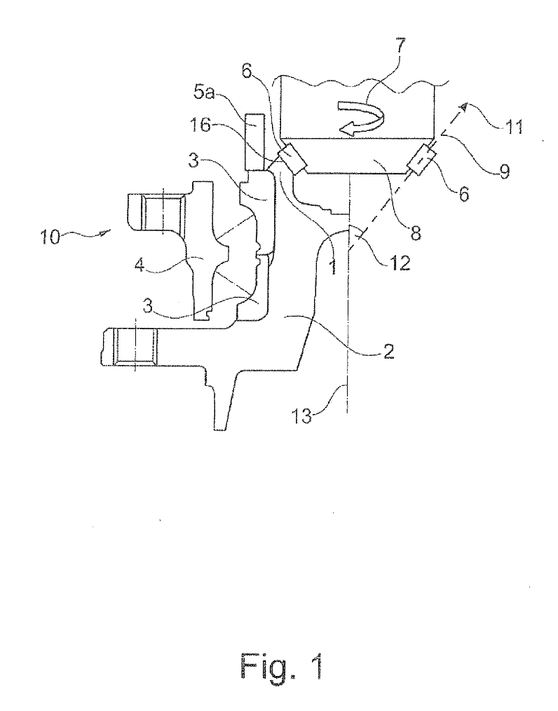

FIG. 1 shows a sectioned view of a wheel bearing during the riveting operation with a single row rolling tool,

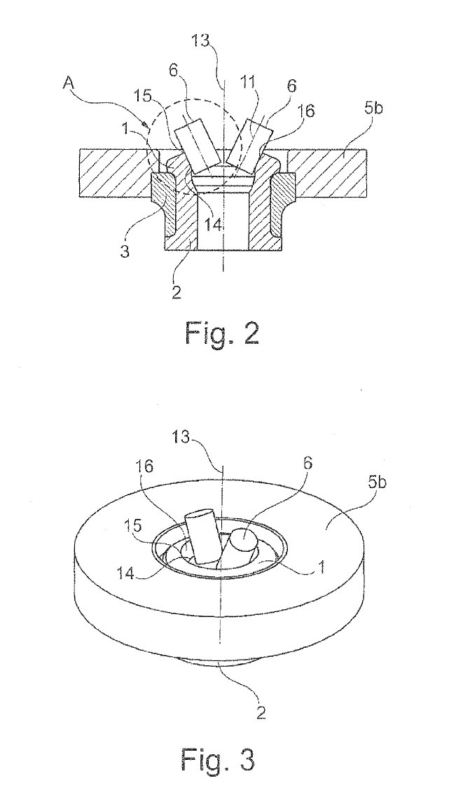

FIG. 2 shows a sectioned view of a wheel bearing with a roll formed face on the rivet flange,

FIG. 3 shows a perspective view of the wheel bearing from FIG. 2,

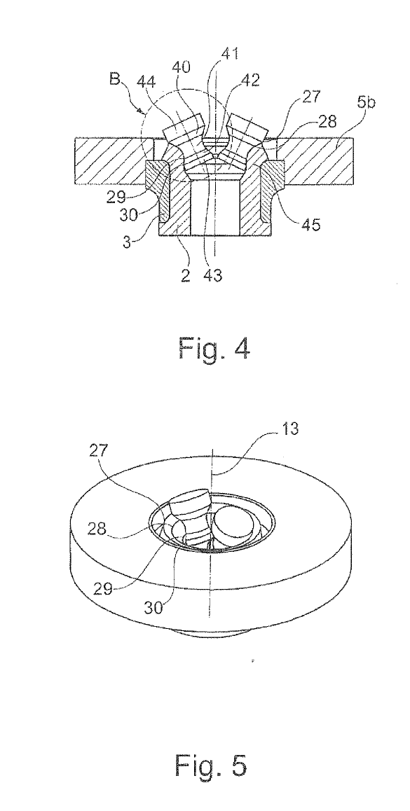

FIG. 4 shows a sectioned view of a wheel bearing with three roll formed faces on the rivet flange,

FIG. 5 shows a perspective view of the wheel bearing from FIG. 4, and

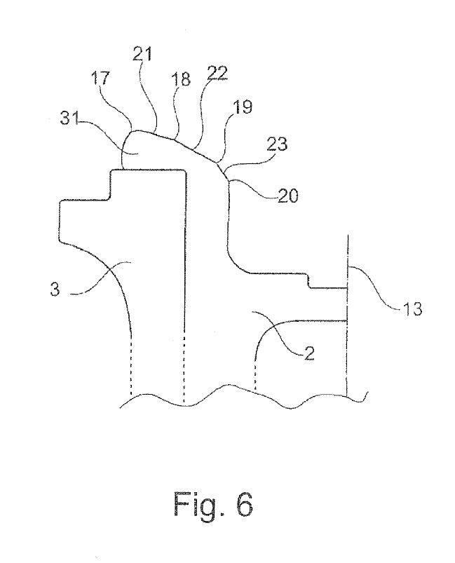

FIG. 6 shows a sectioned view of a partially depicted wheel bearing with three conical, roll formed faces on the rivet flange.

FIG. 1 shows a sectioned view of a wheel bearing 10 during the rolling riveting operation with a single row rolling tool 11, furthermore also called a roll forming tool 11.

The wheel bearing 10 has already been preassembled, that is to say that the inner rings 3 and the outer ring 4 have already been mounted. The rolling bodies of the antifriction bearing 10 are likewise mounted, but are not depicted in FIG. 1. This applies correspondingly to the sealing arrangements which can typically be configured as cassette seals. The lubrication of the wheel bearing 10 has also already been introduced.

The prestress is preferably maintained by a holding element 5a during the riveting, that is to say during the roll forming, which holding element 5a can be fixed by a mechanism (not depicted). In this way, the prestress of the wheel bearing 10 can already be maintained before the cold forming. The prestressing force runs from the gear-side inner ring 3 via the rolling bodies (not depicted) to the outer ring 4, and further from the latter via rolling bodies of the flange-side rolling body row to the flange-side inner ring 3. There, the forces are absorbed by the wheel hub 2. As soon as the cold forming has taken place and the rivet flange 1 is completely formed, the holding element 5a is released and the prestressing force is ensured via the rivet flange 1.

Advantageously, the gear-side inner ring 3 cannot spring back during the roll forming. During header riveting, there is the problem that a prestress also has to be built up continuously during the forming operation. This takes place in a continuous interplay of a deformation operation with a spring-back operation. During the roll forming, in contrast, the deformation and the temporary prestressing by means of the holding element 5a can advantageously be separated. As a result, it is possible to build up a prestress substantially more precisely and to achieve improved production tolerances.

The process of roll forming is advantageously more homogeneous than the header riveting, whereby the riveting operation is simpler and can be controlled more readily. As a result of the force, which can be regulated more precisely, of the holding element (hold-down) on the inner ring, the spring-back and therefore the prestress can be set precisely.

A lower deforming force can advantageously be used during the use of a roll forming tool 11 than in the case of header riveting, whereby the service lives of the roll forming tool 11 can be extended readily and a lower energy consumption can also be expected for the method.

During the roll forming, the roll forming tool 11 rotates in the rotational direction 7, whereby deforming force is transmitted via the rolling bodies of the rolling body row 6 to the rivet flange 1, optionally via a suspension system. The deforming force is produced by the fact that the roll forming tool 11 is driven partially into the deformable part of the wheel hub 2 along the rotational axis 13 of the wheel hub 2.

In this exemplary embodiment, the rolling bodies of the rolling body row 6 are of cylindrical shape, as a result of which a roll formed face 16 is produced on the rivet flange 1. The face 16 lies on an imaginary cone which is centered in the rotational axis 13 and has an opening angle which corresponds to twice the angle 12, the angle 12 lying between the rotational axis 13 and a rotational axis 9 of the rolling bodies of the rolling body row 6.

FIGS. 2 and 3 in each case show a sectioned and a perspective view of a wheel bearing with a roll formed face 16 on the rivet flange 1.

The roll formed face 16 advantageously forms the edges 15 and 14 with the adjacent faces of the rivet flange 1, or the wheel hub 2, whereby the rivet flange 1 can be adapted in an optimum manner to a drive part, for example an articulation bell.

The force direction of the rolling bodies of the roll forming tool 11 can advantageously be selected in such a way that hardening of the rivet flange 1 after the riveting is not necessary and said rivet flange 1 can apply the necessary prestress in the unhardened state.

For illustrative purposes, the rolling bodies 6 of the roll forming tool are depicted in the position which they assume with respect to the rolling rivet flange 1 during the riveting operation. During roll forming, the associated rolling body row rotates about the same axis as the wheel bearing during the operation of the latter.

During the roll forming, the axial extent of the rivet flange 1 is reduced in favor of a greater radial extent. Here, an annular hold-down 5b is advantageously used which rests on the entire circumference of the end side of the inner ring 3. A homogeneous prestress is therefore maintained during the riveting operation.

FIGS. 4 and 5 in each case show a sectioned and a perspective view of a wheel bearing with three roll formed faces on the rivet flange 45. Said faces are delimited by the edges 27, 28, 29, 30.

The rolling bodies of the roll forming tool which are used are likewise depicted and have three differently shaped, noncylindrical regions 41, 42, 43 which can be used for the cold forming. The first face between the edges 27 and 28 has been formed by the conical (cone-like) region of the rolling body and accordingly also has this shape. The second face between the edges 28 and 29 of the rivet flange 45 is convex because it has been formed by a concave region 41 of the rolling bodies. The third, annular face between the edges 29 and 30 is again conical, just like the first face.

The roll formed faces which are produced in each case enclose angles with the rotational axis 13. An angle with respect to the rotational axis can also be specified in the case of concave or convex roll formed faces. For this purpose, a straight line can be formed which runs through the two points of the adjacent, annular edges in the longitudinal plane with respect to the rotational axis. The angle which is formed by said straight line and the rotational axis 13 is also the angle which the roll formed face between the edges encloses with the rotational axis 13. The orientation of the roll formed face can therefore be separated from the design of its shape in a simple way.

The desired shape of the rivet flange 45 can he achieved by way of a single roll forming operation as a result of the special shape of the rolling bodies. In principle, the shape of the rivet flange 45 can also be produced by three following roll forming operations, that is to say two operations with cylindrical or conical rolling bodies and a third operation with concave rolling bodies.

The use of the hold-down 5b corresponds to that of the hold-down 5a from FIGS. 2 and 3.

FIG. 6 shows a sectioned view of a partially depicted wheel bearing having three roll formed faces 21, 22, 23 on the rivet flange 31.

Advantageously, the rivet flange is then generally by an application of different roll forming tools, or the application of different rolling body rows which differ in the shape of their rolling bodies, their orientation or their radial spacing from the rotational axis 13. The rivet flange 31 can therefore be brought into a shape which can be adapted to a drive part in an optimum manner. Previously, the loss of space had been accepted as a result of a barely variable shape of the rivet flange. With the aid of the method according to the invention, the rivet flange 31 can both maintain the prestress, but also be adapted to the surrounding components in an optimum and inexpensive manner.

In the rivet flange 31, four annular edges 17, 18, 19, 20 are formed by the roll formed faces 21, 22, 23. The generation of the roll formed, conical faces 21, 22, 23 permits not only optimum adjustment of the wheel bearing, but also makes precisely defined supporting faces available which can rest flatly on the faces of the drive part, such as an articulation bell, in order to make optimum axial force transmission possible for screwing the antifriction bearing to the articulation bell.

In summary, the invention relates to a rotary forming method for producing a rivet flange of an antifriction bearing, in particular a wheel bearing, a rivet flange being formed from a cylindrical part of a wheel hub by means of a rolling tool which is oriented along a direction of the rotational axis of the wheel hub. The aim is to make the forming operation more advantageous, to keep material stresses low and to set the bearing prestress more accurately. To this end, first rotating rolling bodies of at least one first rolling body row of the rolling tool form the rivet flange, rotational axes of the first rolling bodies of the rolling tool forming a first angle with the rotational axis of the antifriction bearing during the riveting operation. As a result, it is possible to act more homogeneously on the entire circumference of the cylindrical part of the wheel hub with a smaller deforming force and additionally to make temporary prestressing of the antifriction bearing by means of a holding element possible before the cold forming.

### LIST OF DESIGNATIONS

A Detail from FIG. 2

B Detail from FIG. 4

1 Rivet Flange

2 Wheel Hub

3 Inner Ring or Inner Rings

4 Outer Ring

5a, b Holding Element

6 Rolling Bodies

7 Rotational Direction

8 Rolling Body Receptacle

9 Rotational Axis of the Rolling Bodies

10 Wheel Bearing

11 Rolling Tool

12 First Angle

13 Rotational Axis of the Wheel Bearing

14, 15 Edge

16 Roll Formed Face

17, 18, 19, 20 Edge

21, 22, 23 Roll Formed Face

27, 28, 29, 30 Edge

31 Rivet Flange

40, 42 Conical Region

41 Concave Region

43, 44 Cylindrical Region

45 Rivet Flange

1-11. (canceled)

12. A rotary forming method for producing a rivet flange of a wheel hub on which an antifriction bearing is mounted, the method comprising the steps of:
orientating a form rolling tool about a direction of a rotational axis of the wheel hub such that the rolling tool forms a first angle with the rotational axis of the wheel hub; and
rotating the form rolling tool and transmitting a force from the form rolling tool via first rolling bodies of a first rolling body row to a cylindrical part of the wheel hub, deforming the wheel hub and forming a rivet flange.

13. The method as claimed in claim 12, wherein the form rolling tool has a second rolling body row with second rolling bodies, the second rolling bodies have rotational axes which are orientated and form a second angle with the rotational axis of the wheel hub and the form rolling tool transmits a force via the second rolling bodies of the second rolling body row to the wheel hub, forming the rivet flange.

14. The method as claimed in claim 13, wherein the first rolling bodies of the first rolling body row, the second rolling bodies of the second rolling body row, and further rolling bodies of other rolling body rows forming the rivet flange are cylindrical or conical, and the rolling tool forms the rivet flange via the first rolling bodies of the first rolling body row, the second rolling bodies of the second rolling body row, and further rolling bodies of other rolling body rows at a same time.

15. The method as claimed in claim 14, wherein form rolling is carried out with different rolling tools applied one after another, the rolling tools differ in terms of shape of rolling bodies or orientation with respect to the rotational axis of the wheel hub in such a way that deformation forces in different directions act one after another on the cylindrical part of the wheel hub.

16. The method as claimed in claim 12, wherein the antifriction bearing is prestressed by a holding element during formation of the rivet flange.

17. The method as claimed in claim 12, wherein the form rolling tool and/or the wheel hub rotate about a rotational axis of the antifriction bearing during formation of the rivet flange.

18. An assembly, comprising:
a wheel bearing having a first row of rolling bodies; and
a wheel hub cylindrical part,
wherein a rivet flange is produced by a method comprising the following steps: orientating a form rolling tool about a direction of a rotational axis of the wheel hub such that the rolling tool forms a first angle with the rotational axis of the wheel hub; and rotating the form rolling tool and transmitting a force from the form rolling tool via the rolling bodies of the first row to the cylindrical part of the wheel hub, deforming the wheel hub and forming a rivet flange.

19. An antifriction bearing, comprising:
an inner ring;
an outer ring; and
rolling bodies arranged between the inner ring and the outer ring,
wherein the wheel bearing is mountable on a wheel hub having a rivet flange with a roll formed face on a gear side of the wheel hub, and a prestress on the antifriction bearing is maintained by the rivet flange.

20. The antifriction bearing as claimed in claim 19, wherein the antifriction bearing is a wheel bearing.

21. The antifriction bearing as claimed in claim 19, wherein the roll formed face on the rivet flange forms at least one annular edge with another face of the rivet flange.

22. The antifriction bearing as claimed in claim 19, wherein the roll formed face is conical and concave or convex in longitudinal section.

23. The antifriction bearing as claimed in claims 19, wherein the rivet flange has a plurality of roll formed faces on the gear side and each of the roll formed faces forms different angles with respect to a rotational axis of the wheel bearing.
